(19) United States
(12) Patent Application Publication
(10) Pub. No.: US 2007/0067291 A1
(43) Pub. Date: Mar. 22, 2007

(54) System and method for negative entity extraction technique

(76) Inventors: Brian A. Kolo, Centreville, VA (US); John A. Weaver, Washington, DC (US)

Correspondence Address: Brian A. Kolo;Suite 350, 8260 Greensboro Dr., McLean, VA, 22102, US

(21) Appl. No.: 11/521,462

(22) Filed: Sep. 15, 2006

Related U.S. Application Data
(60) Provisional application No. 60/717,750, filed on Sep. 19, 2005.

(51) Int. Cl. G06F 17/30

(52) U.S. Cl. 707/6

(57) ABSTRACT

The present invention is directed toward a technique for the identification of operational entities in unstructured text. The technique consists of the preparation of a series of dictionaries, combining these dictionaries into a single Negative Element Dictionary, then searching an unstructured file for terms matching those in the Negative Element Dictionary. Each term present in the unstructured file but not present in the Negative Element Dictionary is considered an operational entity.

### BACKGROUND OF THE INVENTION

Entity extraction is a common problem faced in the computer automation of document review. This problem often arises when an organization needs to review a large repository of files searching for predefined terms. For instance, a law firm may need to search millions of pages of documentation for a specific individual's name.

This problem may be compounded when there are no predefined terms. An organization may need to review a large document repository and determine the elements generally common to the documents.

### BRIEF SUMMARY OF THE INVENTION

The present invention is directed toward the extraction of operational entities from unstructured data files.

The present invention is also directed to software used to automate the extraction and/or detection of operational entities from unstructured data files.

The present invention is also directed to the determination of common operational entities within a single document. This is referred to the “gist” of the document.

The present invention is also directed to the determination of common operational entities between a plurality of documents.

### BRIEF DESCRIPTION OF THE DRAWINGS

FIG. 1 is a diagram of a positive extraction process.

FIG. 2 is a diagram of the negative extraction process.

FIG. 3 is a flowchart of the process of creating the Negative Entity Dictionary.

FIG. 4a is a Venn diagram showing the relationship between the Word Dictionary and the Name Dictionary.

FIG. 4b is a Venn diagram showing the relationship between the Word Dictionary and the Name Dictionary, where the elements belonging to NED are shown in black.

FIG. 4c is a Venn diagram showing the relationship between the Word Dictionary, the Name Dictionary, and the Common Dictionary.

FIG. 4d is a Venn diagram showing the relationship between the Word Dictionary, the Name Dictionary, and the Common Dictionary, where the elements belonging to NED are shown in black.

FIG. 4e is a Venn diagram showing the relationship between the Word Dictionary and the Name Dictionary, the Common Dictionary, and the Topic Dictionary.

FIG. 4f is a Venn diagram showing the relationship between the Word Dictionary and the Name Dictionary, the Common Dictionary, and the Topic Dictionary, where the elements belonging to NED are shown in black.

### DETAILED DESCRIPTION OF THE INVENTION

Extracting operational entities from an electronic document is the process in which an electronic document is reviewed and a set of words or phrases is determines that capture basic relevant information about the document. This process may be carried out manually by a human operator, or it may be carried out automatically by a computer program.

Speed of execution is often the most important factor. Manual extraction often produces a reliable result, however it is very slow as compared with computer programs. Many business and government entities have millions of documents with unstructured text which need to be searched. The time and expense required to employ a human operator to review each document is prohibitive.

Many organizations prefer an automated solution for entity extraction. Automated solutions are consistent, fast, and able to run 24 hours a day. These solutions are designed to review a document, extract operational entities, and save the results in a data store or create a notification when certain entities are discovered.

Entity extraction algorithms commonly use a database as support. The database is comprised of terms which wish to be identified. A typical algorithm opens a document and examines each word. The word is checked against the dictionary, and if a match is found, this word is added to a list of entities discovered in the document. The process is repeated for each word in the document.

Although this process is very effective for certain types of documents, it falls short in many instances. For example, an entity may appear in the document misspelled. Unless the precise misspelling is present in the dictionary, this process will fail to register the presence of the entity. Additionally, if the extractor seeks to identify names, every name in existence worldwide needs to be present in the dictionary.

This is further complicated by transliteration of names into English. Transliteration is the process of representing a foreign word using the alphabet of English (generally, transliteration is representing a word in one language with the alphabet of another language). This process is often done by attempting to represent the sound of the word with letter combinations approximating that sound. This often leads to a single word having many possible transliterations. For instance, the name Mohamed may commonly be written as Mohamed, Mohammed, Mohamet, Muhammed, etc.

The present invention is directed toward an entity extraction algorithm capable of identifying all operational entities, even when misspelled, and capable of identifying all names. The present invention is distinct over those described above as it is a negative extractor. The details of this invention and its advantages are described below.

A positive extractor is one in which each word is checked against a dictionary, and if the word is found in the dictionary, the word is identified as an entity. This process requires a positive match against the dictionary. Thus, the entities in the document result from the intersection of the document and the dictionary. This is represented in equation 1, where E is the set of entities, ED is the set of words in the electronic document, and D is the set of words in the dictionary.
E=ED∩D, (I)

The present invention is a negative extractor. Each word in the document is checked against a dictionary, and if the word is not found the word is identified as an entity. Thus, the entities in the document result from the document minus the intersection of the document with the dictionary. This is represented in equation 1, where E is the set of entities, ED is the set of words in the electronic document, and D is the set of words in the dictionary.
E=ED−ED∩D. (2)

The dictionary used in the negative extractor contains all words that are not considered entities. Construction of this negative entity dictionary (NED) is the key to the operation of the negative extractor. Three separate dictionaries are required for the proper construction of NED.

The constructing the dictionary begins with creating a first dictionary of all words (Word Dictionary). This dictionary should also contain plurals, contractions, and every verb conjugation. This dictionary will serve as the base core of NED.

Next, a second dictionary is created of all personal names (Name Dictionary). The names should contain male and female first names as well as all surnames. It is not necessary for the Name Dictionary to be a worldwide complete list. Instead, it is sufficient to create a list of names common to the language or languages of the Word Dictionary. This dictionary improves NED by removing all names from the Word Dictionary.

Third, a dictionary is created of common words appearing on the name dictionary (Common Dictionary). When reviewing names, especially last names, it is often the case that some last names are also highly common words. For instance, a complete list of last names in America includes last names of: The, Of, To, And, In, Is, It, and You. Although there are individuals in America with these last names, typically when these words are seen in a document they are not names. Including then as names would lead to significant false positives from the entity extractor. This dictionary improves NED by adding back common English words which may occasionally also be individuals names.

Finally, an optional dictionary or set of dictionaries is included (Topic Dictionary). These dictionary are topic specific and may be included when information is known about the documents. For instance, if the documents involve military operations, a fourth dictionary may be a dictionary of military terms. The words in the dictionary are removed from NED.

NED is constructed by combining these three dictionaries. The core of NED is the Word Dictionary. From this set, the words common to NED and the Name Dictionary are removed from NED. Next, the Common Words are added back into NED. Finally, words in the Topic Dictionary are removed from NED.

Equation 3 mathematically represents the set process for creation of NED. Here WD is the Word Dictionary, ND is the Name dictionary, CD is the Common dictionary and TD's are the Topic Dictionaries.

$$NED = ( WD - WD ⋂ ND ) ⋃ CD - \\ ( ( WD - WD ⋂ ND ) ⋃ CD ) ⋂ {⋃}_{i} {TD}_{i} . \qquad ( 3 )$$

Additional features designed to identify names and places within text may further improve the negative entity extraction process. For instance, if the text contains a mix of capitol and lower case letters, a word that begins with a capitol letter is often a name or place. When using this feature, it is helpful to break the text on sentences and examine each sentence individually. This is helpful because words that begin a sentence are typically capitalized. Thus, a word which begins with a capitol letter and it the first word is a sentence is likely not a place or name. However, when a word begins a sentence and does not begin with a capitol letter, the word is typically a name or place.

Another feature designed to improve detection of names and places is combining consecutive entities. For instance, if the text contains a plurality of consecutive entities, this may also be treated as a single entity by combining the entities together. In the preferred embodiment, this combining process takes place by concatenating the entities together with a single space (‘ ’)between each entity. For instance, if the name ‘Albert Einstein’ is encountered, the entity extractor recognizes ‘Albert’ and ‘Einstein’ as entities. Since these entities appear consecutively, the entity extractor further recognizes ‘Albert Einstein’ as an entity.

There are several advantages to using a negative extractor. First, since the negative entity extractor eliminates words from the text, the words remaining will contain misspellings. Thus, this type of extractor is useful to discover misspelled words or words which contain additional white space (such as a space, tab, carriage return, linefeed, etc.). This occurs frequently in text discovered by an OCR (Object Character Recognition) process. In addition, text generated by a speech-to-text engine often contains misspellings and/or additional white space.

In a less preferred embodiment, the negative entity extractor may work with sound data. In this case, it is desired to search files containing sound data. This data may be processed by using a Speech-To-Text engine to create a text version of the sound file. This text file is then processed in the same manner as described above.

In another less preferred embodiment, the negative entity extractor may work directly with sound data files. In this case, rather than transforming the sound files into text files, the extractor may work directly with the sound files. Again, a series of dictionaries are created using the same process as described above. However, rather than containing words in a text representation, these dictionaries contain sound data. This sound data may be as simple as a single sound (phoneme), or may be a word, a phrase, musical note, or any other sound or combination of sounds.

In another less preferred embodiment, the negative entity extractor may work with image data. In this case, it is desired to search files containing image data such as handwritten notes. This data may be processed by using an Object-Character-Recognition engine to create a text version of the image file. This text file is then processed in the same manner as described above.

In another less preferred embodiment, the negative entity extractor may work directly with image data files. In this case, rather than transforming the image files into text files, the extractor may work directly with the image files. Again, a series of dictionaries are created using the same process as described above. However, rather than containing words in a text representation, these dictionaries contain image data. This image data may be as simple as a single pixel, or may be an object, or any other image or combination of images.

### DETAILED DESCRIPTION OF THE DRAWINGS

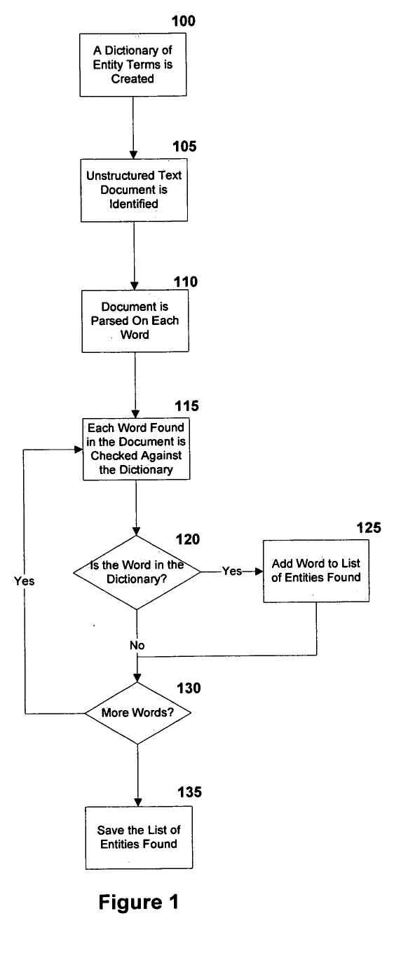

FIG. 1 shows a typical Positive Entity Extraction process. The process begins by identifying a set of terms to find (100). These terms are used to compile a dictionary of terms. It is only necessary to compile this dictionary once. Next, a document comprising unstructured text is identified (105). This document is then parsed word-by-word (110). Each word found in the document is checked against the dictionary (115).

The process then branches by determining if the word is found in the dictionary (120). If the word is found in the dictionary, the word is added to a list of entities found in the document (125). The process then rejoins the main branch.

If the word is not found in the dictionary, the process continues on the main branch. If there are more words in the document to process, the process loops back and checks the next word (130). If there are no more words to check, the list of entities found in the document are saved along with a reference to the document (135).

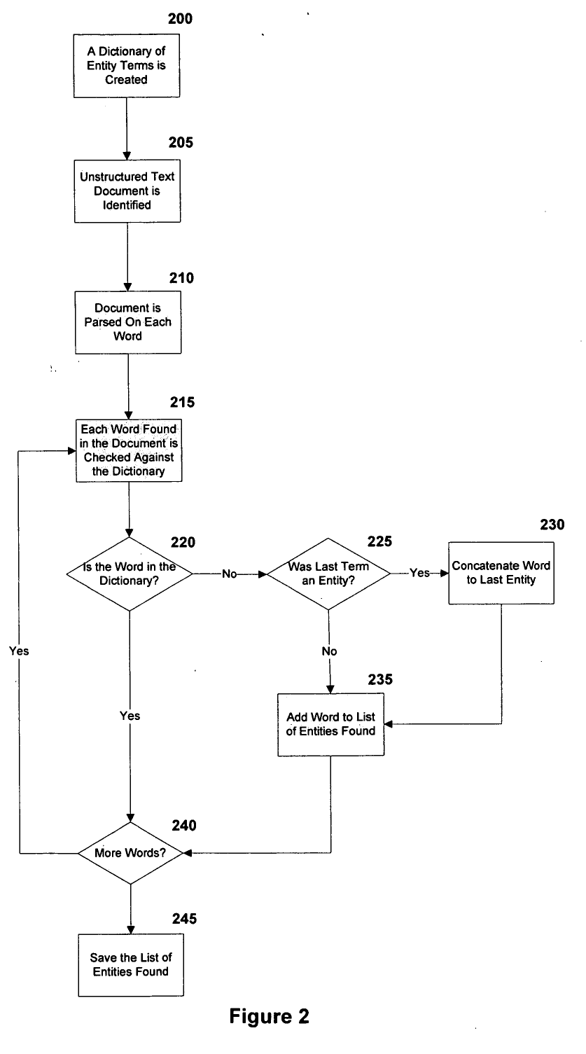

FIG. 2 shows the negative entity extraction process. First NED is compiled (200). These terms are used to compile a dictionary of terms. It is only necessary to compile this dictionary once. Next, a document comprising unstructured text is identified (205). This document is then parsed word-by-word (210). Each word found in the document is checked against NED (215).

The process then branches by determining if the word is found in NED (220). If the word is NOT found in NED, the word is added to a list of entities found in the document (235). Optionally, if a sequence of consecutive entities are found (225), they may be concatenated together to form a single entity (230). The concatenation process typically separates the concatenated entities with a space (‘ ’) or dash (‘-’). The concatenated entity is added to the list of entities found (235). The process then rejoins the main branch.

If the word is found in NED, the process continues on the main branch. If there are more words in the document to process, the process loops back and checks the next word (240). If there are no more words to check, the list of entities found in the document are saved along with a reference to the document (245).

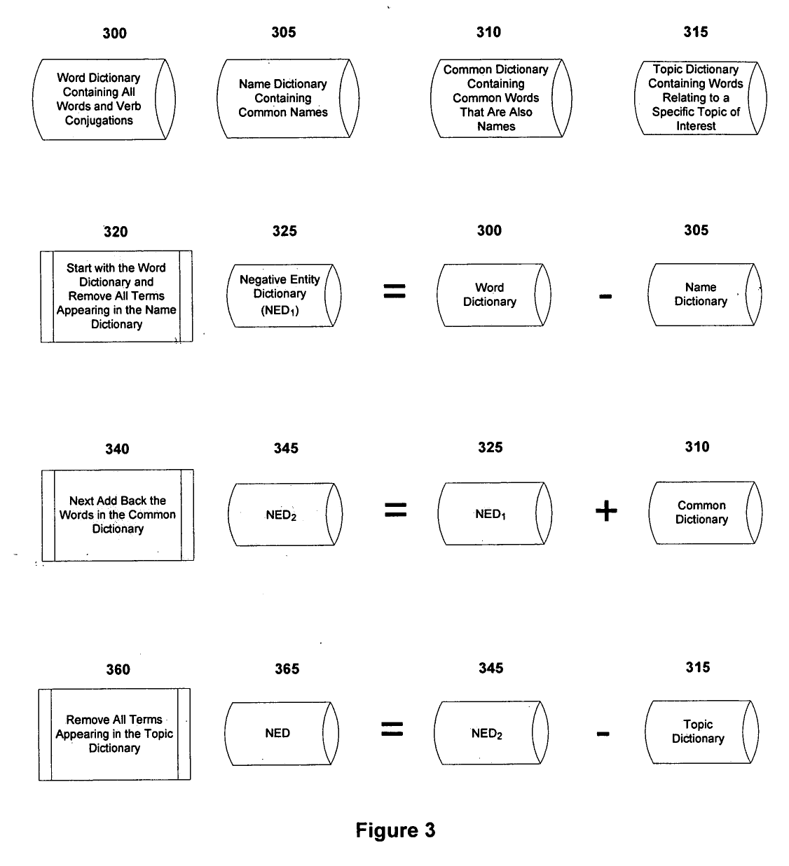

FIG. 3 shows the process of creating NED. First, the relevant dictionaries are identified. These dictionaries are combined by adding and subtracting elements. After all dictionaries have been combines, the final dictionary created is NED.

A Word Dictionary (300) is created containing all words of interest in the language. This dictionary should also contain each plural, contraction, verb conjugation, and every other form a word may appear.

A Name Dictionary (305) is created containing all first and last names common to the language of the Word Dictionary. Only the names common to the language or culture of the Word Dictionary are needed. In addition, not every transliterated spelling variant is required. Only the most common variants are needed.

A Common Dictionary (310) is created after examining the Name Dictionary. This examination may be done by hand, or it may be completed using statistical information of the relative frequencies or rankings of the names. If may be the case that an uncommon name such as Do is also a common word. A decision is made this word should be treated as a word or as a name. If it is decided to treat the word as a name, nothing need to be done. If it is decided to treat the word as a word, the word is added to the Common Dictionary.

A Topic Dictionary (315) is created with words common to a topic. For instance, if military terms are the topic, words such as general, corporal, bomb, ordnance, fighter, and carrier may be added to the topic dictionary. A plurality of Topic Dictionaries may be created covering a variety of topics.

The first step in the creation of NED is to remove elements from the Word Dictionary (300). The elements to remove are those that are common to both the Word Dictionary (300) and the Name Dictionary (305). Thus, all elements found in the Name Dictionary (305) are subtracted from the Word Dictionary (300). The resulting dictionary is called NED₁ (325) in FIG. 3.

Next, the elements in the common dictionary are added back (340). The resulting combination of NED₁ (325) and the Common Dictionary (310) is termed NED₂ (345).

Optionally, the terms from any Topic Dictionaries (315) are removed (360). The dictionary resulting from this step is termed NED (365) in FIG. 3. If no Topic Dictionaries (315) are used, the NED₂ (345) is used as the NED (365).

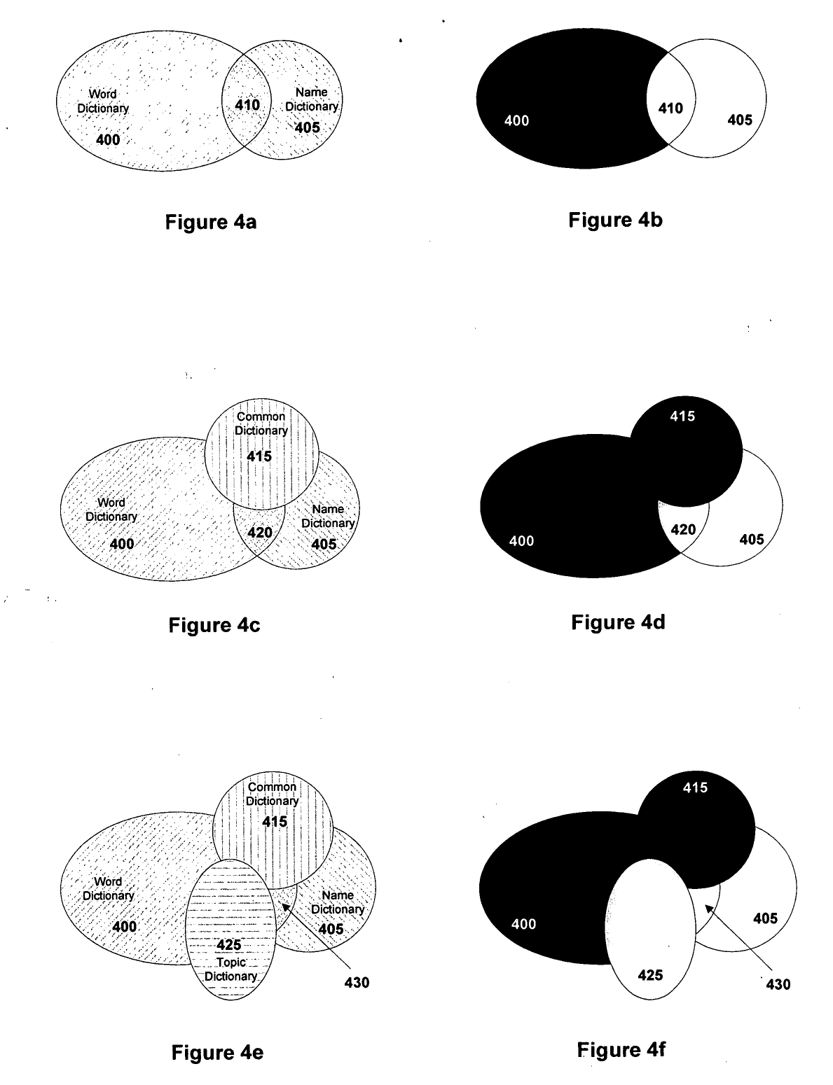

FIGS. 4a-f shows the process of creating NED in terms of Venn diagrams.

In FIG. 4a, the intersecting sets of the Word Dictionary (400) and the Name Dictionary (405) are indicated. In addition, the intersection of these sets (410) is indicated. NED, (325) results from the subtraction from the Word Dictionary (400) of the intersection of the Word Dictionary (400) and the Name Dictionary (405). FIG. 4b shows the results of this process. Here, the dark area is the elements retained after the subtraction process. FIG. 4c shows the addition of the Common Dictionary (415) to the set. Here, the region common to the Word Dictionary (400) and Name Dictionary (405), but not in common to the Common Dictionary (415) is indicated (420). The elements present in this new dictionary is indicated as the dark area in FIG. 4d.

FIG. 4e shows the removal of the Topic Dictionary (425). The region common to the Word Dictionary (400) and the Name Dictionary (405), but uncommon to either the Common Dictionary (415) or Topic Dictionary (425) is indicated (430). The elements present in the new dictionary created after removal of the elements in the Topic Dictionary (425) is indicated as the dark area in FIG. 4f. This final area indicated the elements present in NED.

### Other Embodiments

It should be appreciated that the particular implementations shown and described herein are illustrative of the invention and its best mode and are not intended to otherwise limit the scope of the present invention in any way. Indeed, for the sake of brevity details of the potential forms of the documents have been ignored. These documents may be presented in a common format such as a text file, MS Word, Adobe Acrobat, a MS Office product, or any other computer readable format.

It should be appreciated that the entity extractor described is not limited to working with English words but may be used in any language. English words were used in this document to illustrate the process. In addition, the entity extractor is capable of working with a plurality of languages simultaneously. This may be implemented by incorporating several languages into the dictionary, or applying a plurality of single language extractors in parallel to a single document.

It should also be appreciated that it is contemplated the entity extractor may work with documents in an encrypted form. The entity extractor may be designed to work with an unencrypted form of the document, or it may be designed to work directly with the encrypted document.

It should also be appreciated that it is contemplated that the words in the Common Dictionary may be added depending on the relative frequency of the name verses the relative frequency of the word. For instance, a method to determine if a specific name found in the Name Dictionary should also be added to the Common Dictionary may involve an algorithm with inputs comprising the relative frequency of the name and the relative frequency of the word in common language.

In addition, rather than using relative frequencies, it is also contemplated to use the rank ordered popularity. In this case, a list of names is sorted by popularity. The words may also be sorted by popularity. The algorithm to determine if a specific name should be added back to the Common Dictionary may include inputs comprising the rank ordered popularity of word as a name along with the word as a word.

Additionally, it is contemplated that an algorithm determining whether a given word should be added to the Common Dictionary may include as inputs any combination of the relative frequency of the word, the rank ordered popularity of the word, the relative frequency of the name, and/or the rank ordered popularity of the name.

It should be appreciated that the sound data files may be in a variety of formats. For instance, the sound files may be file types such as .wav, .mpeg, .mp2, .mp3, avi, .wfb, .wfd, .wfp, or any other computer readable file format comprising sound data.

We claim:

1. A method for extracting operational entities from a data source comprising terms, comprising:
a) A Negative Entity Dictionary comprising terms are not considered entities; and
b) A means for comparing each term in the data source with the dictionary of words; and
c) Extraction of operational entities by creating a list of terms in the data source that are not found in the dictionary of words.

2. The method of claim 1 where the operational entities are comprised of personal names.

3. The method of claim 2 where the list of terms comprises misspelled terms.

4. The method of claim 1 where the Negative Entity Dictionary is created comprising the following steps:
a) A Dictionary of Words comprising terms considered not entities is identified; and
b) A Name Dictionary comprising personal names is identified; and
c) A Common Words Dictionary comprising commonly used terms which are not considered entities is identified; and
d) The Negative Entity Dictionary is created by:
I) Removing from the Dictionary of Words all terms from the Name Dictionary; and
II) Adding to the result of (I) all terms in the Common Words Dictionary.

5. The method of claim 4 further comprising the step:
e) A Topic Dictionary comprising terms relating to a topic of interest relevant to the operational entities; and
III) Removing from the result of (II) all terms in the Topic Dictionary.

6. The method of claim 4 where the terms are selected from the group comprising: typed terms, spoken terms, handwritten terms, and images.

7. The method of claim 5 where the terms are spoken words.

8. A system for extracting operational entities from a data source comprising terms, comprising:
a) A Negative Entity Dictionary comprising terms are not considered entities; and
b) A software system comprising a means for comparing each term in the data source with the dictionary of words; and
c) Extraction of operational entities by creating a list of terms in the data source that are not found in the dictionary of words.

9. The system of claim 8 where the operational entities are comprised of personal names.

10. The system of claim 9 where the list of terms comprises misspelled terms.

11. The system of claim 8 where the Negative Entity Dictionary is created comprising the following steps:
a) A Dictionary of Words comprising terms considered not entities is identified; and
b) A Name Dictionary comprising personal names is identified; and
c) A Common Words Dictionary comprising commonly used terms which are not considered entities is identified; and
d) The Negative Entity Dictionary is created by:
I) Removing from the Dictionary of Words all terms from the Name Dictionary; and
II) Adding to the result of (I) all terms in the Common Words Dictionary.

12. The system of claim 11 further comprising the step:
e) A Topic Dictionary comprising terms relating to a topic of interest relevant to the operational entities; and
III) Removing from the result of (II) all terms in the Topic Dictionary.

13. The system of claim 11 where the terms are selected from the group comprising: typed terms, spoken terms, handwritten terms, and images.

14. The system of claim 12 where the terms are spoken words.
